(19) United States
(12) Patent Application Publication
(10) Pub. No.: US 2003/0215543 A1
(43) Pub. Date: Nov. 20, 2003

(54) Plasticized corn proteins and chewing gums containing same

(76) Inventors: Jingping Liu, Highland Park, NJ (US); Willy W. Lee, Bridgewater, NJ (US); John M. Meyer, Kendall Park, NJ (US)

Correspondence Address: BELL, BOYD & LLOYD LLC, P. O. BOX 1135, CHICAGO, IL, 60690-1135, US

(21) Appl. No.: 10/151,586

(22) Filed: May 16, 2002

(51) Int. Cl. A23G 3/30

(52) U.S. Cl. 426/3

(57) ABSTRACT

Methods of making gum base and chewing gums and products so produced are provided. To this end, methods for selecting effective plasticizers for corn protein are provided. The plasticizer selection methods are based on a calculation of the ratio of electron acceptors to the total number of carbon atoms of the plasticizer, and a calculation of the ratio of electron donors to the total number of carbon atoms of the plasticizer.

### BACKGROUND OF THE INVENTION

The present invention relates generally to chewing gum compositions and methods for making same. More specifically, the present invention relates to plasticizers for chewing gums as well as gum bases and gums including same.

Conventional chewing gums usually contain synthetic elastomers, resins, fats, waxes, minerals, emulsifiers, plasticizers and antioxidants as well as sweeteners and flavors. Each ingredient contributes a particular feature toward the overall properties of the chewing gums. Due to the chemical composition of conventional chewing gums, such gums are not suitable for ingestion by humans. More specifically, the synthetic elastomers used in conventional chewing gums are neither ingestible nor readily degradable. Conventional chewing gums must therefore be removed from the mouth and discarded after chewing. Typically, chewed gum is properly discarded by wrapping it in its wrapper or other substrate and disposing of same.

Chewing gums that contain synthetic elastomers readily adhere to almost any dry surface, such as skin, wood, concrete, paper, and cloth. Once adhered to a surface, they can be difficult to remove and typically undergo a very slow degradation process. Therefore, improperly disposed of chewed gum can potentially raise environmental concerns. Therefore, an environmentally-friendly chewing gum, which is ingestible and/or easily removable/degradable, is highly desirable.

Unlike the synthetic flexible elastomers used in conventional chewing gums, the pure forms of most ingestible polymers such as proteins and polysaccharides are rigid and not suitable as chewing elastomers without plasticizers. In the presence of large amounts of plasticizers, such as water, alcohol and glycerin or polyols, some proteins and polysaccharides can become elastic at body temperature. However, due to their polar structures, typical digestible polymers such as starches, albumins and globulins have a tendency to be dissolved or dispersed in the mouth quickly and thus cannot withstand prolonged chewing. Therefore, water-insoluble digestible polymers, such as prolamines and glutelins, both of which are proteins, may be selected for formulating environmentally-friendly chewing gums.

Prolamines, which are water-insoluble proteins found in the seeds of cereals, have been used in some consumer applications. Prolamines have been considered for use in chewing gum products. Prolamines can be plasticized by agents such as propylene glycol, ethylene glycol, acetic acid, lactic acid, polypropylene glycol, polyethylene glycol, glycerol and ethanol. The difficulty with such plasticizers, however, is that they are water-soluble, resulting in a proteinaceous gum product that cannot withstand a long period of chewing when compared to conventional chewing gums.

Zein is a water insoluble prolamine obtained from corn gluten. Zein is a nutritious and readily biodegradable substance. Zein has been discussed as a potential chewing gum material. See for example U.S. Pat. Nos. 2,154,482; 2,489,147; 4,474,749; 4,931,295; 5,112,625; 5,164,210; 5,482,722; 5,882,702; 6,020,008 and non-U.S. Patents and Published Applications JP07163300, JP02211828, JP04079846, and JP06133735. Common plasticizers for zein include water, aqueous ethanol, glycerin, and polyols, but again, such water-soluble substances do not result in gums that provide adequate chew times.

Despite ongoing research involving corn protein plasticizing agents suitable for the production of chewing gums, the chemical interactions between corn proteins and potential plasticizers are still not clearly understood. Selection of an effective plasticizer for corn protein therefore remains a challenging task.

### SUMMARY OF THE INVENTION

The present invention relates to improved plasticizers and methods of selecting plasticizers to be incorporated into chewing gums. The present invention further provides improved chewing gum bases and finished chewing gum products as well as improved methods for making same.

To this end, the present invention provides, in an embodiment, a method for selecting a plasticizer for corn proteins for the purpose of forming chewing gum comprising the steps of calculating the ratio of electron acceptors to the total number of carbon atoms (EA/C) of a plasticizer, calculating the ratio of electron donors to the total number of carbon atoms (ED/C) of the plasticizer, and selecting the plasticizer based on the EA/C and ED/C ratios.

In an embodiment, the preferred EA/C is in the range of approximately 0.05 to about 1.5, and the ED/C is in the range of approximately 0.05 to about 2.0.

In an embodiment, the EA/C is approximately 0.08 to about 1.0 and the ED/C is approximately 0.1 to about 1.1.

In an embodiment, the corn protein to be plasticized is at least one selected from the group consisting of α-zein, β-zein, γ-zein, δ-zein, glutelins, other corn proteins, and combinations thereof.

In an embodiment, the plasticizer comprises at least one electron acceptor and at least one electron donor.

In an embodiment, the plasticizer is a single component that comprises at least one electron acceptor and at least one electron donor.

In an embodiment, the plasticizer comprises a mixture of two or more components such that the mixture possesses at least one electron acceptor and at least one electron donor.

In an embodiment, the electron acceptors are selected from the group consisting of hydrogen from hydroxyl, carboxylic acid, amino, imine, sulfhydryl, and aldehyde functional groups and combinations thereof.

In an embodiment, the electron donors are selected from the group consisting of oxygen, sulfur, and nitrogen in hydroxyl, carbonyl, ether, amino, imine and sulfhydryl functional groups, and non-conjugated carbon-carbon double bonds and combinations thereof.

In an embodiment, the plasticizer is selected from the group consisting of hydroxyl acids/hydroxyl acid esters/polyhydroxy acids including dibutyl tartrate, dipropyl tartrate, diethyl tartrate, ethyl lactate, propyl lactate, butyl lactate, malic acid, hydroxybutyric acid, glycolic acid, malic acid dibutylester, malic acid dipropylester, malic acid diethylester, hydroxybutyric acid butylester, hydroxybutyric acid propylester, hydroxybutyric acid ethylester, glycolic acid butylester, glycolic acid propylester, glycolic acid ethylester, polylactic acids, polyhydroxybutyric acid, polyglycolic acid or hydroxyl acid copolymers, mono-/di-glycerides, organic acid consisting of propanoic acid, butyric acid, oleic acid, linoleic acid, linolenic acid, abietic acid, dihydroabietic acid, dehydroabietic acid, rosin, butyl citrate, ethyl citrate, and combinations thereof.

In a further embodiment, the present invention provides for a method of producing a gum base comprising the steps of combining a corn protein and a plasticizer. The plasticizer is selected by calculating the EA/C of the plasticizer, calculating the ED/C of the plasticizer, and selecting the plasticizer whose EA/C is in the range of approximately 0.05 to about 1.5, and whose ED/C is in the range of approximately 0.05 to about 2.0.

In an embodiment, the temperature during the gum base-making process is in the range of approximately 20 to about 80° C.

In a further embodiment, the present invention provides for a chewing gum base that comprises corn protein and a plasticizer. The plasticizer is selected by calculating the EA/C of the plasticizer, calculating the ED/C of the plasticizer, and selecting the plasticizer whose EA/C is in the range of approximately 0.05 to about 1.5, and whose ED/C is in the range of approximately 0.05 to about 2.0.

In an embodiment, the gum base can have a corn protein content of approximately 10 to about 90%, preferably approximately 20 to about 70%, and most preferably approximately 30 to about 60% by weight based on the total weight of the base.

In an embodiment, the gum base can have a plasticizer content of approximately 5 to about 50%, preferably approximately 10 to about 40%, and most preferably approximately 20 to about 30% by weight based on the total weight of the base.

In an embodiment, the gum base further comprises at least one component selected from the group consisting of protein/protein hydrolysate and polysaccharide and combinations thereof

In an embodiment, the protein/protein hydrolysate component is selected from the group consisting of zein, gelatin, hydrolyzed gelatin, collagen, hydrolyzed collagen, casein, caseinate, gliadin, wheat gluten, glutenin and hordein and combinations thereof.

In an embodiment, the polysaccharide is selected from the group consisting of starch, modified starch, dextrin, maltodextrin, hydroxypropylmethylcellulose, dietary fiber, pectin, alginate, natural gum and combinations thereof.

In another embodiment, the present invention provides for a method of manufacturing a chewing gum comprising the step of combining corn protein, a flavoring, and a plasticizer. The plasticizer is selected by calculating the EA/C of the plasticizer, calculating the ED/C of the plasticizer, and selecting the plasticizer whose EA/C is in the range of approximately 0.05 to about 1.5, and whose ED/C is in the range of approximately 0.05 to about 2.0.

In an embodiment, the temperature during the chewing gum-making process is in the range of approximately 25 to about 60° C.

In a further embodiment, the present invention provides for a chewing gum comprising corn protein, a flavoring, and a plasticizer. The plasticizer is selected by calculating the EA/C of the plasticizer, calculating the ED/C of the plasticizer, and selecting the plasticizer whose EA/C is in the range of approximately 0.05 to about 1.5, and whose ED/C is in the range of approximately 0.05 to about 2.0.

In an embodiment, the present invention provides for a chewing gum that is sugar free.

In an embodiment, the present invention provides for a chewing gum that is environmentally friendly.

In an embodiment, the present invention provide for a chewing gum that displays reduced adhesion to environmental surfaces after being chewed.

It is an advantage of the present invention to provide an improved method for selecting plasticizers for chewing gum.

It is an advantage of the present invention to provide a method for predicting effective plasticizers for corn protein by computationally analyzing the chemical structure of a candidate plasticizer, thus reducing trial and error mixing in the laboratory of candidate plasticizers with corn protein.

Still a further advantage of the present invention is to provide an improved chewing gum base.

Another advantage of the present invention is to provide an improved method for making gum base.

Still further an advantage of the present invention is to provide an improved chewing gum.

Another advantage of the present invention is to provide an improved method for making chewing gum.

Moreover, an advantage of the present invention is that the gum base is biodegradable.

Furthermore, an advantage of the present invention is to provide an environmentally-friendly chewing gum.

Additional features and advantages of the present invention are described in, and will be apparent from, the following Detailed Description of the Invention and the figures.

### DETAILED DESCRIPTION OF THE INVENTION

The present invention provides improved plasticizing agents that can be used in producing gum bases and chewing gum compositions. The present invention additionally provides gum bases and chewing gum compositions, including the plasticizers. By using the plasticizer selection method of the present invention, chewing gum cuds can be ingestible and more environmentally friendly than conventional chewing gum cuds. In this regard, the gum cuds resulting from the present invention have less adhesive characteristics, resulting in reduced adhesion of improperly discarded gum cuds to environmental surfaces such as wood, concrete, fabric, carpet, metal, and other sources.

Zein is a protein of the prolamine class present in maize. While zein has polar amino acid groups in its main chain, its side chains are composed of more than 50% nonpolar amino acid residues such as leucine, isoleucine, valine, alanine, phenylalanine and glycine. This kind of structure makes zein insoluble in water at neutral pH but highly swellable. Its amphiphilic nature makes zein incompatible with most common plasticizers. Currently, few effective plasticizers of zein are known. Such plasticizers include propylene glycol, ethylene glycol, acetic acid, lactic acid, poly(propylene glycol), poly(ethylene glycol), glycerol, ethanol and fatty acids.

A plasticizer varies the firmness of gum base by interposing itself between the macromolecular chains of a target compound. This is best accomplished when the attractive forces between the molecules of both components are similar. If the attractive forces are sufficiently dissimilar, immiscibility will result. Attraction forces between molecules typically include dispersion force, polar forces, hydrogen bonding forces and ionic forces. It is well known that ionic forces and hydrogen-bonding typically play important roles in protein dissolution in aqueous solution. In non-aqueous media, the hydrogen-bonding tends to become the major driving force to form miscible blends between zein and plasticizers. Plasticizers are required to possess sufficient electron donors and electron acceptors in their molecular structures in order to form effective hydrogen bonding with zein macromolecules. In this regard, due to the amphiphilic nature of zein, the most effective plasticizers for zein are those that possess a balance of hydrophobic and hydrophilic portions in their molecular structures similar to zein.

It has been surprisingly found that effective plasticizers of zein can be predicted by assessing the composition of electron acceptors and electron donors within a given candidate plasticizer. One must first calculate the ratio of electron acceptors to the total number of carbon atoms (EA/C) of the candidate plasticizer. The next step is to calculate the ratio of electron donors to the total number of carbon atoms (ED/C) of the candidate plasticizer. The most effective plasticizers of zein appear to be those whose EA/C is in the range of approximately 0.05 to about 1.5, preferably approximately 0.08 to about 1.0, most preferably approximately 0.15 to about 0.67; and whose ED/C is in the range of approximately 0.05 to about 2.0, preferably approximately 0.1 to about 1.1, and most preferably approximately 0.3 to about 0.9.

The most preferential ranges stated above are those that most closely encompass the EA/C and ED/C values (using the same ratio calculation process) of zein, which are approximately 0.30 to about 0.37 and approximately 0.57 to about 0.59, respectively. It is well known in chemical parlance that “like dissolves like,” which is why the most effective plasticizers for zein are those compounds that possess amphiphilic properties similar to zein.

With regard to selecting candidate plasticizers, electron acceptors can include hydrogen in hydroxyl (—OH), carboxylic (—COOH), amino (—NH—), imine (═NH), and sulfhydryl (—SH) groups. The electron donors can include oxygen, sulfur, nitrogen in hydroxyl, carboxylic, ester, ketone, ether, amino, imine, sulfhydryl functional groups and non-conjugated carbon-carbon double bonds.

Compounds suitable as candidate plasticizers may include hydroxyl acid/hydroxyl acid ester/polyhydroxy acid groups consisting of dibutyl tartrate, dipropyl tartrate, diethyl tartrate, ethyl lactate, propyl lactate, butyl lactate, hydroxybutyric acid, glycolic acid, malic acid dibutylester, malic acid dipropylester, malic acid diethylester, hydroxybutyric acid butylester, hydroxybutyric acid propylester, hydroxybutyric acid ethylester, glycolic acid butylester, glycolic acid propylester, glycolic acid ethylester, polylactic acids, polyhydroxybutyric acid, polyglycolic acid or hydroxyl acid copolymers, mono-/di-glycerides organic acid consisting of propanoic acid, oleic acid, linoleic acid, linolenic acid, abietic acid, dihydroabietic acid, dehydroabietic acid, rosin and the mixtures.

Chewing gum generally consists of a water soluble gum base, a water soluble sweetener, and flavors. The insoluble gum base generally comprises elastomers, resins, fats and oils, softeners, and inorganic fillers. The elastomers of the present invention can include ingestible polymers such as various forms of zein, including α-zein, β-zein, γ-zein, δ-zein, as well as other corn proteins.

Selected plasticizers can be blended with zein or other corn proteins to form ingestible elastomer substances. This can be done at approximately 20 to about 65° C., preferably at approximately 35 to about 55° C. In order to produce an environmentally-friendly gum base, the plasticized zein elastomer can be further combined with other ingestible ingredients that may include polysaccharides, proteins or their hydrolysates, ingestible acids emulsifiers, and lipids. Polysaccharides may include native starches, modified starches, dextrins, maltodextrin, hydroxypropylmethylcellulose, dietary fibers, pectins, alginates, carrageenan, gellan gum, xanthan gum, gum arabic, guar gum or other natural gums. The preferred polysaccharides are maltodextrin and high-conversion dextrins. Preferably, the chewing gum bases comprise about approximately 5 to about 10% by weight polysaccharides. Among digestible proteins, hydrolyzed collagens or gelatins are preferred; the preferred content is approximately 10 to about 20% by weight in the base.

The chewing gum bases of the present invention can have a corn protein content of approximately 10 to about 90%, preferably approximately 20 to about 70%, and most preferably approximately 30 to about 60% by weight based on the total weight of the base. Furthermore, the gum base can have a plasticizer content of approximately 5 to about 50%, preferably approximately 10 to about 40%, and most preferably approximately 20 to about 30% by weight based on the total weight of the base.

The gum base can also include fillers and optional minor amounts of ingredients such as colorants, antioxidants, etc.

Fillers/texturizers may include magnesium and calcium carbonate, ground limestone, silicate types such as magnesium and aluminum silicate, clay, alumina, talc, titanium oxide, mono-, di- and tri-calcium phosphate, cellulose polymers, such as wood, and combinations thereof.

Colorants and whiteners may include FD&C-type dyes and lakes, fruit and vegetable extracts, titanium dioxide, and combinations thereof.

The base may or may not include wax. An example of a wax-free gum base is disclosed in U.S. Pat. No. 5,286,500, the disclosure of which is incorporated herein by reference.

In addition to a water insoluble gum base portion, a typical chewing gum composition includes a water soluble bulk portion and one or more flavoring agents. The water soluble portion can include bulk sweeteners, high intensity sweeteners, flavoring agents, emulsifiers, colors acidulants, fillers, antioxidants, and other components that provide desired attributes.

Bulk sweeteners include both sugar and sugarless components. Bulk sweeteners typically constitute 5 to about 95% by weight of the chewing gum, more typically, 20 to 80% by weight, and more commonly, 30 to 60% by weight of the gum.

Sugar sweeteners generally include saccharide-containing components commonly known in the chewing gum art, including, but not limited to, sucrose, dextrose, maltose, dextrin, dried invert sugar, fructose, levulose, galactose, corn syrup solids, and the like, alone or in combination.

Sorbitol can be used as a sugarless sweetener. Additionally, sugarless sweeteners can include, but are not limited to, other sugar alcohols such as mannitol, xylitol, hydrogenated starch hydrolysates, maltitol, lactitol, and the like, alone or in combination.

High intensity artificial sweeteners can also be used in combination with the above. Preferred sweeteners include, but are not limited to sucralose, aspartame, salts of acesulfame, alitame, saccharin and its salts, cyclamic acid and its salts, glycyrrhizin, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extension may be used to achieve the desired release characteristics.

Usage level of the artificial sweeteners will vary greatly and will depend on such factors as potency of the sweetener, rate of release, desired sweetness of the product, level and type of flavor used and cost considerations. Thus, the active level of artificial sweetener may vary from 0.02 to about 8%. When carriers used for encapsulation are included, the usage level of the encapsulated sweetener will be proportionately higher.

Combinations of sugar and/or sugarless sweeteners may be used in chewing gum. Additionally, the softener may also provide additional sweetness such as with aqueous sugar or alditol solutions.

If a low calorie gum is desired, a low caloric bulking agent can be used. Example of low caloric bulking agents include: polydextrose; Raftilose, Raftilin; Fructooligosaccarides (NutraFlora); Palatinose oligosaccharide; Guar Gum Hydrolysate (Sun Fiber); or indegestible dextrin (Fibersol). However, other low calorie bulking agents can be used.

A variety of flavoring agents can be used. The flavor can be used in amounts of approximately 0.1 to about 15 weight percent of the gum and, preferably, about 0.2 to about 5%. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorially acceptable fashion.

By way of example and not limitation, examples of the present invention will now be given.

### EXAMPLE 1

The ratios of electron acceptors to carbon number (EA/C) and electron donors to carbon number (ED/C) values of various materials have been calculated and are shown in Table 1. In order to determine the calculations the following materials were used. Propanoic acid, ethyl propionate and propylene glycol were obtained from Spectrum Chemical Mfg. Corp. (New Brunswick, N.J.). Ethyl lactate, n-propyl lactate, isopropyl lactate, butyl lactate, ethylhexylester of lactic acid were obtained from PURAC America Inc. (Lincolnshire, Ill.). Lactic acid was obtained from Archer Daniels Midland Co. Polylactic acid oligomers were synthesized by L. A. Dreyfus Co. (Edison, N.J.). Dibutyl tartrate was obtained from Aldrich Chemical Co. (Milwaukee, Wis.). All other samples were obtained from Mallinckrodt Baker, Inc. (Phillipsburg, N.J.).

The following procedure was followed: 10 g of liquid samples were added to individual vials containing Ig zein powder (Freeman Industries, L.L.C., Tuckahoe, N.Y.). The vials were vigorously shaken on a Wrist Action Shaker for 30 minutes and set aside for 24 hours at room temperature. The contents of the vials were then examined to determine their miscibility.

It was found that when the EA/C value of a given plasticizer was within approximately 0.10 to about 0.67, and the ED/C value of that plasticizer was in the range of approximately 0.3 to about 1.0, the zein/plasticizer mixture displayed complete miscibility. If either the ED/C or the EA/C of a given plasticizer was out of these ranges, no true solution was observed.

TABLE 1

| | | | zein/plasticizer |
|---|---|---|---|
| | EA/C | ED/C | mixture (1:10) |
| zein | 0.30-0.37 | 0.57-0.59 | |
| Propanoic acid | 0.33 | 0.67 | Clear, one phase |
| Diethyl tartrate | 0.25 | 0.75 | Clear, one phase |
| Dibutyl tartrate | 0.17 | 0.5 | Clear, one phase |
| Propylene glycol | 0.67 | 0.67 | Clear, one phase |
| Ethyl lactate | 0.20 | 0.6 | Clear, one phase |
| n-Propyl lactate | 0.17 | 0.5 | Clear, one phase |
| Isopropyl lactate | 0.17 | 0.5 | Clear, one phase |
| Butyl lactate | 0.14 | 0.4 | Clear, one phase |
| Butandiol | 0.5 | 0.5 | Clear, one phase |
| Lactic acid | 0.67 | 1 | Clear, one phase |
| Acetic acid | 0.5 | 1 | Clear, one phase |
| Ethylene glycol | 0.33 | 0.67 | Clear, one phase |
| monomethyl ether | | | |
| PLA dimer | 0.33 | 0.83 | |
| PLA trimer | 0.22 | 0.78 | |
| PLA tetramer | 0.17 | 0.67 | |
| PLA oligomer | Mixture of di- | tri-, tetra- mers | Clear, one phase |
| ethyl propionate | 0 | 0.4 | insoluble |
| ethylhexylester of | 0 | 0.27 | insoluble |
| lactic acid | | | |
| methanol | 1 | 1 | Cloudy, two phase |
| butanol | 0.25 | 0.25 | Cloudy, two phase |
| Good miscibility | 0.10-0.67 | 0.3-1.0 | |
| range | | | |

### EXAMPLE 2

As seen above in Example 1, the best plasticizers of zein are those compounds whose EA/C is from approximately 0.10 to about 0.67 and whose ED/C is from approximately 0.3 to about 1.0. Nevertheless, compounds whose EA/C and ED/C ratios fall within the broader ranges of approximately 0.05 to about 1.5 and approximately 0.1 to about 2.0, respectively (but outside the ideal ranges shown in Example 1), can still be effective plasticizers of zein in the presence of an additional plasticizing component (See Table 2).

For example, as shown below, oleic acid and linoleic acid cannot individually dissolve zein directly as the method shown in Example 1. However, miscibility did occur when 10 g of 10% zein/aqueous isopropanol solution were mixed with 0.3 g oleic acid (Spectrum Chemical Mfg. Corp., New Brunswick, N.J.). After the solvent evaporated at ambient temperature overnight, a clear and soft film was formed. This method can also be used for the test of solid plasticizers such as rosin (a mixture of the isomers of abietic acid, dehydroabietic acid, dihydroabietic acid), malic acid and tartaric acid.

TABLE 2

| | | | zein /plasticizer |
|---|---|---|---|
| | EA/C | ED/C | mixture (10:3) |
| rosin | 0.05 | 0.20 | Clear, brittle film |
| Oleic acid | 0.06 | 0.17 | Clear, soft film |
| Conjugated | 0.06 | 0.22 | Clear, soft film |
| Linoleic acid | | | |
| Linolenic acid | 0.06 | 0.28 | |
| Polypolyene glycol | 0.02 | 0.66 | Cloudy, oily (2 phase) |
| (PPG2000) | | | |
| PPG1200 | 0.04 | 0.65 | Cloudy, oily (2 phase) |
| Malic acid | 0.75 | 1.25 | Slight cloudy film, no |
| | | | macro phase separation |
| Tartaric acid | 1 | 1.5 | Opaque film, no macro |
| | | | phase separation |
| Miscible Range | 0.05-1.5 | 0.1-2 | |

### EXAMPLE 3

In this example, a gum base containing zein and dibutyl tartrate was prepared. Thirty-six grams of zein were added to a C. W. Brabender mixer (Model DDRV501, Brabender Corp., South Hackensack, N.J.), followed by the addition of 15 g dibutyl tartrate and 21 g distilled water during agitation. The mixture became pasty and translucent after 30 minute at 50° C./32 rpm. The mixture was then discharged. The base was soft and elastic.

### EXAMPLE 4

In this example, a gum base containing zein and butyl lactate was prepared. Thirty-six grams of zein were added to a Brabender mixer followed by 20 g butyl lactate and 10 g distilled water during agitation. The mixture became pasty and translucent after 30 minute at 50° C./32 rpm. Subsequently, 6 g gelatin (Leiner Davis Gelatin) and 6 g maltodextrin (Grain Processing Corp., Muscatine, Iowa) were added into the mixer. After 30 minutes of further mixing, the mixture was discharged. The base was soft and elastic at room temperature.

### EXAMPLE 5

In this example, a gum base containing zein and propyl lactate was prepared. Thirty-six grams of zein were added to a Brabender mixer followed by 20 g propyl lactate and 10 g distilled water during agitation. The mixture became pasty and translucent after 30 minute at 50° C./32 rpm. Subsequently, 6 g gelatin and 6 g maltodextrin was added into the mixer. After 30 minutes of further mixing, the mixture was discharged. The base was soft and elastic at room temperature.

### EXAMPLE 6

In this example, a gum base containing zein and ethyl lactate was prepared. Thirty-six grams of zein were added to a Brabender mixer, followed by 20 g ethyl lactate and 10 g distilled water during agitation. The mixture became pasty and translucent after 30 minute at 50° C./32 rpm. Subsequently, 6 g gelatin and 6 g maltodextrin were added into the mixer. After 30 minutes of further mixing, the mixture was discharged. The base was soft and elastic at room temperature.

### EXAMPLE 7

In this example, a gum base containing zein and propanoic acid was prepared. Thirty-six grams of zein were added to a Brabender mixer followed by 20 g propanoic acid and 10 g distilled water during agitation. The mixture became pasty and translucent after 30 minute at 50° C./32 rpm. Subsequently, 6 g gelatin and 6 g maltodextrin were added into the mixer. After 30 minutes of further mixing, the mixture was discharged. The base was soft and elastic at room temperature.

### EXAMPLE 8

In this example, a gum base containing zein and malic acid was prepared. Fifteen grams of malic acid were added to a beaker with 15 ml water and stirred until a clear solution was obtained. Thirty-six grams of zein were added to a Brabender mixer along with the malic acid/water solution described above. The mixture became homogenous and paste-like after 30 minute at 50° C./32 rpm. Subsequently, 6 g gelatin and 6 g maltodextrin were added into the mixer. After 30 minutes of further mixing, the mixture was discharged.

### EXAMPLE 9

In this example, a gum base containing zein and polylactic acid oligomers was prepared. Thirty-six grams of zein were added to a Brabender mixer and 20 g polylactic acid oligomers (L. A. Dreyfus Co., Edison, N.J.) was added during agitation. The mixture became pasty and translucent after 60 minute at 80° C./32 rpm. The mixture was then discharged. The base was soft and elastic.

### EXAMPLE 10

In this example, a gum base containing zein, lactic acid, and oleic acid was prepared. Thirty-six grams of zein were added to a Brabender mixer followed by 20 g 88% food grade lactic acid (Archer Daniels Midland Co., Decatur, Ill.) and 10 g oleic acid during agitation. The mixture became pasty and translucent after 60 minute at 80° C./32 rpm. The mixture was then discharged. The base was soft and elastic.

### EXAMPLE 11

In this example, a gum base containing zein, propanoic acid, and conjugated linoleic acid was prepared. Thirty grams of zein were added to a Brabender mixer and then 20 g food grade propanoic acid and 10 g conjugated linoleic acid (Stepan Co., Maywood, N.J.) were added during agitation. The mixture became pasty and translucent after 60 minute at 80° C./32 rpm. Subsequently, 6 g gelatin and 6 g maltodextrin were added into the mixer. After 30 minutes of further mixing, the mixture was discharged. The base was soft and elastic.

### EXAMPLE 12

In this example, a sugarless gum containing zein and polylactic acid oligomers was prepared. To a Brabender mixer (setting at 60° C. and 30 rpm), 50 g of the gum base prepared in Example 9 was added and agitated for 10 minutes. 6 g mannitol and 0.5 g acesulfame K were then added. After 10 minutes of further mixing, 0.5 ml fruit flavor was added and mixed for another 10 minutes. After discharge, the gum dough was rolled and pressed into a thin sheet and cut into gum cubes.

### EXAMPLE 13

In this example, a sugarless gum containing zein and dibutyl tartrate was prepared. To a Brabender mixer (setting at 60° C. and 30 rpm), 50 g of the gum base prepared in Example 3 was added and agitated for 10 minutes. 6 g gelatin and 6 g maltodextrin were then added into the mixer. After 30 minutes of further mixing, 6 g mannitol and 0.5 g acesulfame K were added. After 10 minutes of further mixing, 0.5 ml fruit flavor was added and mixed for an additional 10 minutes. After discharge, the gum dough was rolled and pressed into a thin sheet and cut into gum cubes.

### EXAMPLE 14

In this example, a sugarless gum containing zein, lactic acid, and oleic acid was prepared. To a Brabender mixer (setting at 60° C. and 60 rpm), 50 g of the gum base prepared in Example 10 along with 25 g sugar and 0.5 g acesulfame K were added and mixed for 10 minutes. 0.5 ml fruit flavor was added and mixed for an additional 10 minutes. After discharge, the gum dough was rolled and pressed into a thin sheet and cut into gum cubes.

### EXAMPLE 15

In this example the removeabililty of gum prepared pursuant to the present invention was examined. Three pieces of gum made in Examples 12 and 13, respectively, were washed in a water bath overnight and finger-kneaded in lukewarm water for 2 minutes. The gum cuds were then pressed onto a concrete block and heated in an oven at 40° C. for 3 days. The gum cuds were then aged at room temperature for 1 week. The gum cuds were found cracked and easily removable by a common broom.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A method of preparing a gum base comprising the steps of mixing corn protein and a plasticizer, the plasticizer having a ratio of electron acceptors to total carbon atoms in the range of approximately 0.05 to about 1.5, and a ratio of electron donors to total carbon atoms in the range of approximately 0.05 to about 2.0.

2. The method of claim 1, wherein the plasticizer has a ratio of electron acceptors to total carbon atoms in the range of approximately 0.08 to about 1.0, and a ratio of electron donors to total carbon atoms in the range of approximately 0.1 to about 1.1.

3. The method of claim 1, wherein the plasticizer has a ratio of electron acceptors to total carbon atoms in the range of approximately 0.15 to about 0.67, and a ratio of electron donors to total carbon atoms in the range of approximately 0.3 to about 0.9.

4. The method of claim 1, wherein the corn protein to be plasticized is selected from the group consisting of α-zein, β-zein, γ-zein, δ-zein, glutelins and combinations thereof.

5. The method of claim 1, wherein the plasticizer is a single component that comprises at least one electron acceptor and at least one electron donor.

6. The method of claim 1, wherein the plasticizer comprises a mixture of at least two components such that the mixture possesses at least one electron acceptor and at least one electron donor.

7. The method of claim 1, wherein the electron acceptors are selected from the group consisting of hydrogen from hydroxyl, carboxyl, amino, imine, sulfhydryl, and aldehyde functional groups and combinations thereof.

8. The method of claim 1, wherein the electron donors are selected from the group consisting of oxygen, sulfur, and nitrogen in hydroxyl, carboxylic, ester, ketone, ether, amino, imine and sulfhydryl functional groups, and non-conjugated carbon-carbon double bonds and combinations thereof.

9. The method of claim 1 wherein the plasticizer is selected from the group consisting of hydroxyl acids/hydroxyl acid esters/polyhydroxy acids including dibutyl tartrate, dipropyl tartrate, diethyl tartrate, ethyl lactate, propyl lactate, butyl lactate, malic acid, hydroxybutyric acid, glycolic acid, malic acid dibutylester, malic acid dipropylester, diethylester, hydroxybutyric acid butylester, hydroxybutyric acid propylester, hydroxybutyric acid ethylester, glycolic acid butylester, glycolic acid propylester, glycolic acid ethylester, polylactic acids, polyhydroxybutyric acid, polyglycolic acid or hydroxyl acid copolymers, mono-/di-glycerides organic acid consisting of propanoic acid, butyric acid, oleic acid, linoleic acid, linolenic acid, abietic acid, dihydroabietic acid, dehydroabietic acid, rosin, butyl citrate, ethyl citrate, and combinations thereof.

10. The method of claim 1, wherein the temperature during the gum base-making process is in the range of approximately 20 to about 80° C.

11. A gum base comprising:
corn protein and a plasticizer, the plasticizer having a ratio of electron acceptors to total carbon atoms in the range of approximately 0.05 to about 1.5, and a ratio of electron donors to total carbon atoms in the range of approximately 0.05 to about 2.0.

12. The gum base of claim 11, wherein the plasticizer has a ratio of electron acceptors to total carbon atoms in the range of approximately 0.08 to about 1.0, and a ratio of electron donors to total carbon atoms in the range of approximately 0.1 to about 1.1.

13. The gum base of claim 11, wherein the plasticizer has a ratio of electron acceptors to total carbon atoms in the range of approximately 0.15 to about 0.67, and a ratio of electron donors to total carbon atoms in the range of approximately 0.3 to about 0.9.

14. The gum base of claim 11, wherein the electron acceptors are selected from the group consisting of hydrogen from hydroxyl, carboxyl, amino, imine, sulfhydryl, and aldehyde functional groups and combinations thereof.

15. The gum base of claim 11, wherein the electron donors are selected from the group consisting of oxygen, sulfur, and nitrogen in hydroxyl, carboxylic, ester, ketone, ether, amino, imine and sulfhydryl functional groups, and non-conjugated carbon-carbon double bonds and combinations thereof.

16. The gum base of claim 11, wherein the corn protein is selected from the group consisting of α-zein, β-zein, γ-zein, δ-zein, glutelins and combinations thereof.

17. The gum base of claim 11, wherein the corn protein component is approximately 10 to about 90% by weight based on the total weight of the base.

18. The gum base of claim 11, wherein the content of the selected plasticizer component is approximately 5 to about 50% by weight of the total weight of the base.

19. The gum base of claim 11, wherein the gum base further comprises at least one component selected from the group consisting of protein, protein hydrolysate, polysaccharide and combinations thereof.

20. The gum base of claim 11, further comprising a component selected from the group consisting of zein, gelatin, hydrolyzed gelatin, collagen, hydrolyzed collagen, casein, caseinate, gliadin, wheat gluten, glutenin, hordein and combinations thereof.

21. The gum base of claim 11, further comprising a polysaccharide selected from the group consisting of starch, modified starch, dextrin, maltodextrin, hydroxypropylmethylcellulose, dietary fiber, pectin, alginate, natural gum and combinations thereof.

22. A method of producing a chewing gum comprising the steps of:
combining a water soluble portion, a flavor, and a water insoluble portion comprising corn protein and a plasticizer, the plasticizer having a ratio of electron acceptors to total carbon atoms in the range of approximately 0.05 to about 1.5, and a ratio of electron donors to total carbon atoms in the range of approximately 0.05 to about 2.0.

23. The method of claim 22, wherein the plasticizer has a ratio of electron acceptors to total carbon atoms in the range of approximately 0.08 to about 1.0, and a ratio of electron donors to total carbon atoms in the range of approximately 0.1 to about 1.1.

24. The method of claim 22, wherein the plasticizer has a ratio of electron acceptors to total carbon atoms in the range of approximately 0.15 to about 0.67, and a ratio of electron donors to total carbon atoms in the range of approximately 0.3 to about 0.9.

25. The method of claim 22, wherein the electron acceptors are selected from the group consisting of hydrogen from hydroxyl, carboxyl, amino, imine, sulfhydryl, and aldehyde functional groups and combinations thereof.

26. The method of claim 22, wherein the electron donors are selected from the group consisting of oxygen, sulfur, and nitrogen in hydroxyl, carboxylic, ester, ketone, ether, amino, imine and sulfhydryl functional groups, and non-conjugated carbon-carbon double bonds and combinations thereof.

27. The method of claim 22, wherein the corn protein component is selected from the group consisting of α-zein, β-zein, γ-zein, δ-zein, glutelins and combinations thereof.

28. The method of claim 22, wherein the temperature during the gum-making process is in the range of approximately 25 to about 60° C.

29. A chewing gum comprising:
a water soluble portion, a flavor, and a water insoluble portion comprising corn protein and a plasticizer, the plasticizer having a ratio of electron acceptors to total carbon atoms in the range of approximately 0.05 to about 1.5, and a ratio of electron donors to total carbon atoms in the range of approximately 0.05 to about 2.0.

30. The chewing gum of claim 29, wherein the plasticizer has a ratio of electron acceptors to total carbon atoms in the range of approximately 0.08 to about 1.0, and a ratio of electron donors to total carbon atoms in the range of approximately 0.1 to about 1.1.

31. The chewing gum of claim 29, wherein the plasticizer has a ratio of electron acceptors to total carbon atoms in the range of approximately 0.15 to about 0.67, and a ratio of electron donors to total carbon atoms in the range of approximately 0.3 to about 0.9.

32. The chewing gum of claim 29, wherein the corn protein component is selected from the group consisting of α-zein, β-zein, γ-zein, δ-zein, glutelins and combinations thereof.

33. The chewing gum of claim 29, wherein the chewing gum further includes a high-intensity sweetener.

34. The chewing gum of claim 29, wherein the chewing gum is sugar free.

35. A method of producing environmentally friendly chewing gum comprising the steps of:
combining a water soluble portion, a flavor, and a water insoluble portion comprising corn protein and a plasticizer, the plasticizer being selected based on a ratio of electron acceptors to total carbon atoms, and a ratio of electron donors to total carbon atoms.

36. The method of claim 35, wherein the plasticizer has a ratio of electron acceptors to total carbon atoms in the range of approximately 0.05 to about 1.5, and a ratio of electron donors to total carbon atoms in the range of approximately 0.05 to about 2.0.
